(19) United States
(12) Patent Application Publication
(10) Pub. No.: US 2009/0139143 A1
(43) Pub. Date: Jun. 4, 2009

(54) Door Hinge Finger Guard

(76) Inventor: Diane Camet, San Diego, CA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/949,486

(22) Filed: Dec. 3, 2007

(51) Int. Cl. E06B 9/01

(52) U.S. Cl. 49/50

(57) ABSTRACT

An apparatus for preventing a door from closing, thereby avoiding injuries, such as pinching of fingers or other body parts, that occur on both the handle and hinge side of the door. The apparatus is a wedge-shaped device that comprises a wedge-portion and an attached handle. The handle is placed over a door hinge to secure the device in place, and the wedge-portion is shaped to fit between the edge of the door and the door frame, thereby preventing the door from closing beyond a predetermined angle.

### FIELD OF THE INVENTION

The present invention relates to an apparatus for preventing a door from closing. The apparatus is an effective device designed to avoid injuries that could result from fingers or other body parts being pinched by a door when it closes.

### INTRODUCTION

There are several types of safety devices, such as door guards, that are utilized to prevent the accidental pinching of fingers or other body parts when a door is closed. Door guards, in particular, prevent injuries that occur on both the handle and hinge side of the door. Some devices serve as a shield and block the cavity that forms between the edge of the door and the door frame, but they often involve rigorous installation procedures that require screws to secure the device to the door and door frame. There exists a need for a device that will prevent injuries on both the handle and hinge side of the door, and that is also easy to both install and remove.

The present invention is a door hinge guard that utilizes a wedge-shaped device which is easily installed over a hinge and can likewise be easily removed. The invention further prevents injuries that could occur on both the handle and hinge side of the door. The invention comprises a wedge-portion and a handle that extends from the wedge-portion. The handle is slipped over a door hinge to secure the device in place and the wedge-portion is shaped in such a way to fit between the door frame and the edge of the door, thereby preventing the door from closing. Consequently, the wedge-portion can be designed to keep the door open at some predetermined minimum angle. For example, if the door is desired to be kept open at an angle of at least 90 degrees, the size of the wedge-portion will be larger than if the door is desired to be kept open at an angle of at least 30 degrees.

### BRIEF DESCRIPTION OF THE DRAWINGS

The invention is better understood by reading the following detailed descriptions with reference to the accompanying drawings in which:

FIG. 1 is an exemplary depiction of the invention.

FIG. 2a is a front view diagram of the invention with exemplary dimensions.

FIG. 2b is a side view diagram of the invention with exemplary dimensions.

FIG. 2c is a top view diagram of the invention with exemplary dimensions, and does not depict the attached handle.

FIG. 2d is a top view diagram of the invention with exemplary dimensions, with a depiction of the attached handle.

FIGS. 3-9 are perspective design drawings depicting the ornamental features of an exemplary embodiment of the present invention.

### DETAILED DESCRIPTION OF THE INVENTION

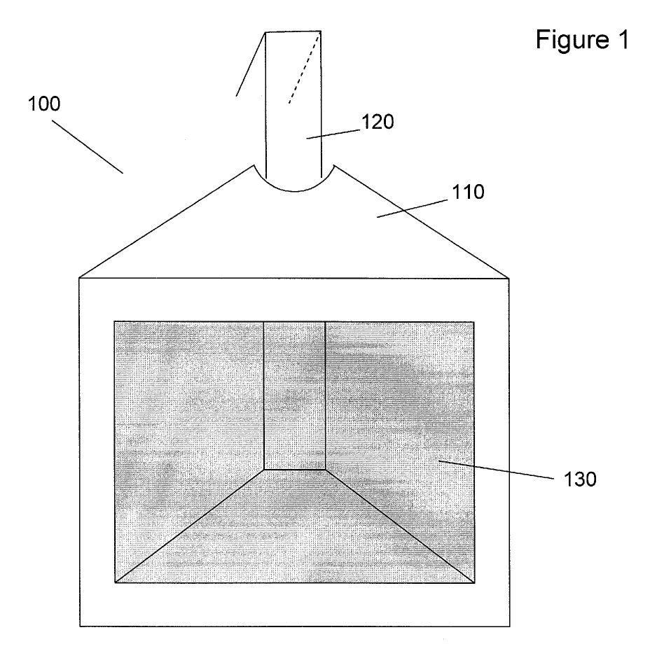

Referring to FIG. 1, the invention is a wedge-shaped device 100 comprised of a wedge-portion 110 and an attached handle 120. The handle 120 extends outward from the wedge-portion 110 such that the handle 120 can be placed over a hinge attached to a door. The handle 120 is preferably placed over the top hinge so that a child or animal is less able to accidentally remove the device 100. One advantage of the invention is that the user can easily install the device simply by placing it over a hinge, and it can likewise be easily removed.

The preferred embodiment depicts the handle 120 extending from the top of the wedge-portion 110. This placement of the handle 120 allows it to be slipped over the top of the hinge to secure it in place. In alternate embodiments, however, it is envisioned that for added security the handle 120 could extend from the bottom of the wedge-portion 110, such that the handle 120 could first wrap around the bottom of the hinge and then over the top of the hinge.

The wedge-portion 110 is shaped in such a way that when fitted between the door frame and edge of the door, the door will be unable to close beyond a certain predetermined angle. In the preferred embodiment the wedge-portion 110 is shaped such that the door cannot be closed past approximately 90 degrees. In alternate embodiments the wedge-portion 110 can be shaped such that the door cannot close past any predefined angle, so long as the door remains open and the cavity between the edge of the door and door frame has sufficient clearance so that injuries (such as fingers or animal tails being pinched) are avoided.

The wedge-portion 110 and handle 120 are preferably composed of a silicone material. The material is durable, light-weight, and robust enough to withstand pressure that may be exerted on the door, such as by a child who attempts to close the door. In alternate embodiments it is envisioned that the wedge-shaped device 100 could be composed of other types of materials, such as different types of plastics, wood, rubber, metal materials, etc.

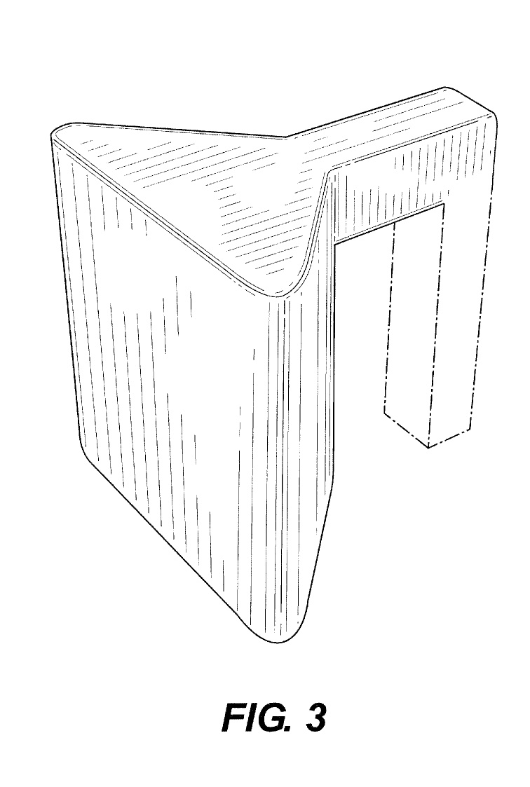

As depicted in FIG. 1, the wedge-portion 110 has a concave-like inner area 130; however the inner area 130 of the wedge-portion 110 could alternatively be solid, as shown in FIG. 3.

The preferred embodiment is so dimensioned as to satisfy standard doors and door frames, and hinges; however one skilled in the art could easily vary the size of the invention to fit other doors and door frames, and hinges.

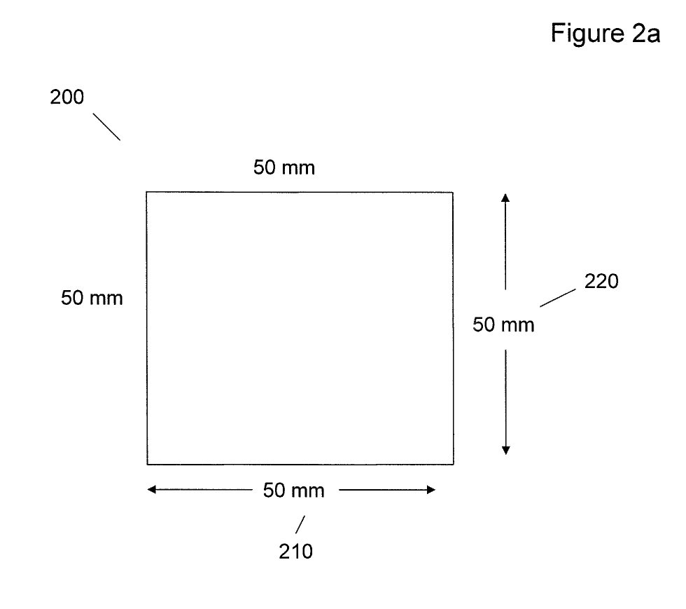

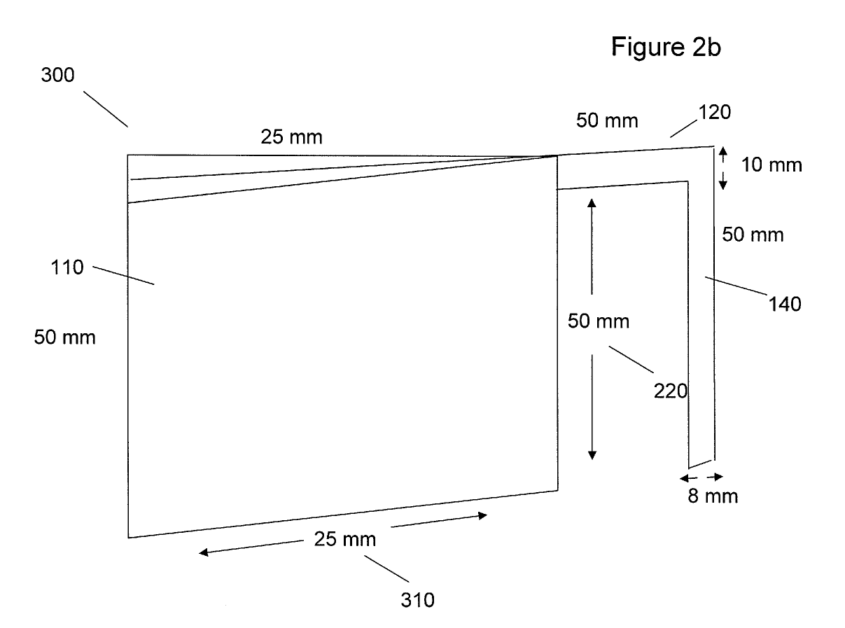

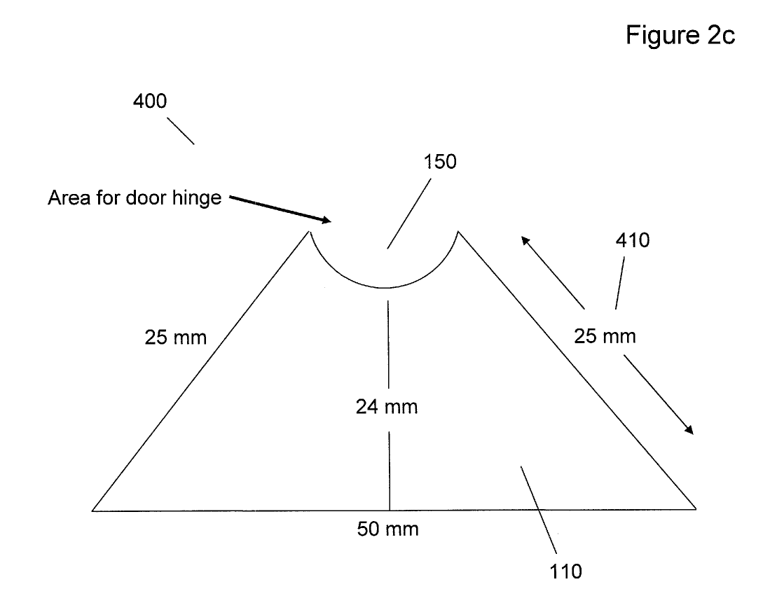

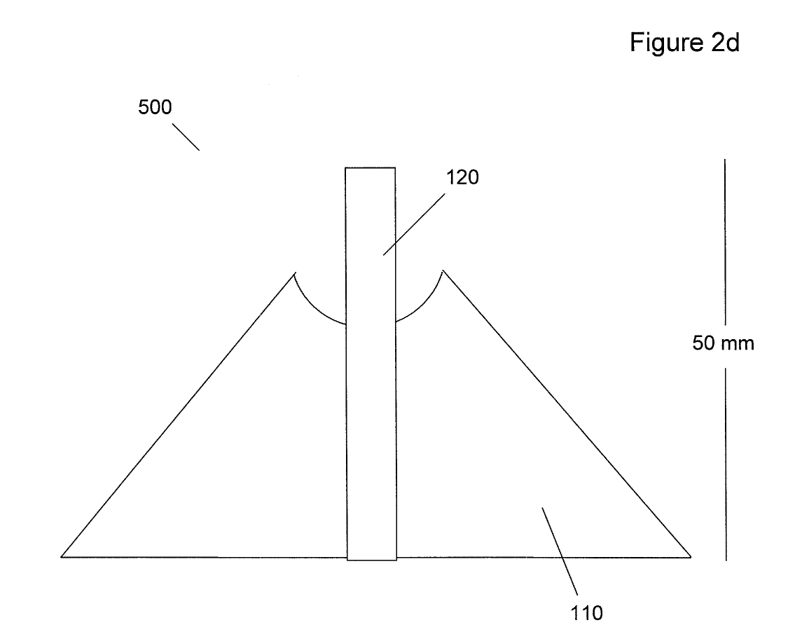

In one embodiment, FIG. 2a depicts a front view 200 of the wedge-portion 110 with exemplary dimensions of 50 millimeters for the width 210 and height 220. FIG. 2b is a side view 300 of the invention that depicts the side of the wedge-portion 110 with a depth 310 of approximately 25 millimeters and an approximate height 220 of 50 millimeters. The top of the handle 120 extends outward from the top of the wedge-portion 110, for a total depth of 50 millimeters. The top portion of the handle 120 is approximately 10 millimeters thick. The downward portion of the handle 140 extends approximately 50 millimeters from top to bottom and is 8 millimeters wide. However, other handle lengths are possible and generally the downward portion of the handle 140 is of sufficient length and/or weight to counterbalance the weight of the wedge portion 110 when the handle 140 and the wedge portion 110 are hanging on opposite sides of the hinge. Alternatively, the handle 140 may further be constructed to include a locking member (not shown) at the bottom of the downward portion of the handle 140 (i.e., on the end nearest the floor) such that the locking member grabs onto the bottom of the hinge to further aid in preventing the wedge-shaped device 100 from falling off of the hinge. In addition, although the handle 120 is illustrated as fixedly attached to the wedge portion 110, the handle 120 may instead be removably connected to the wedge portion 110 or the handle 120 may be slidably connected to the wedge portion 110 such that the downward portion of the handle 140 may be moved closer to or farther away from the wedge portion 110 in order to accommodate different door and/or hinge configurations. By sliding the wedge portion 110 toward the downward portion of the handle 140, the device 100 may stored more compactly.

FIG. 2c depicts the top view 400 of the wedge-portion 110 without the handle 120. As illustrated, the angled sides 410 of the wedge-portion 110 extend backward approximately 25 millimeters. A semicircular portion 150 at the rear end of the wedge-portion 110 is cut out approximately 24 millimeters from the front of the wedge-portion 110, so that the wedge-portion 110 will fit comfortably against the cylindrical portion of the hinge (not shown). Finally, FIG. 2d depicts a top view 500 of the attached handle 120, with a total depth of approximately 50 millimeters from the front of the wedge-portion 110 to the rear of the handle 120. The above-mentioned dimensions are exemplary in nature for the preferred embodiment and are not meant to limit the invention in any way.

In an alternate embodiment, the device has an adjustable wedge-portion (not shown) that can have multiple settings. A pin, an adjustable pin, a spring, or a similar device can be positioned horizontally between the two angled sides 410 so that the adjustable wedge-portion can be collapsed or set at different degree settings (e.g., 45 or 90 degrees). The adjustable wedge-portion adjusts about a hinge that is incorporated into the wedge-portion (e.g., near the handle 120). This feature would provide flexibility in setting the door to a desired angle, without having to change out devices. Alternatively, the single handle 120 may be disconnected from a wedge of one width and connected to a wedge of another width.

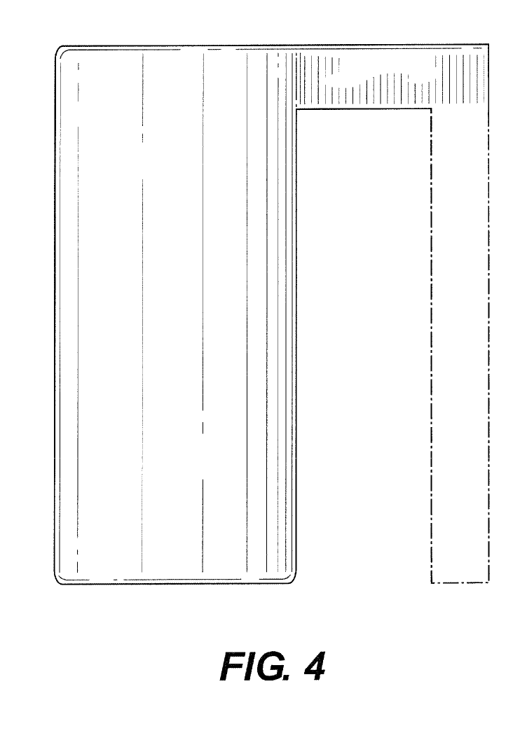

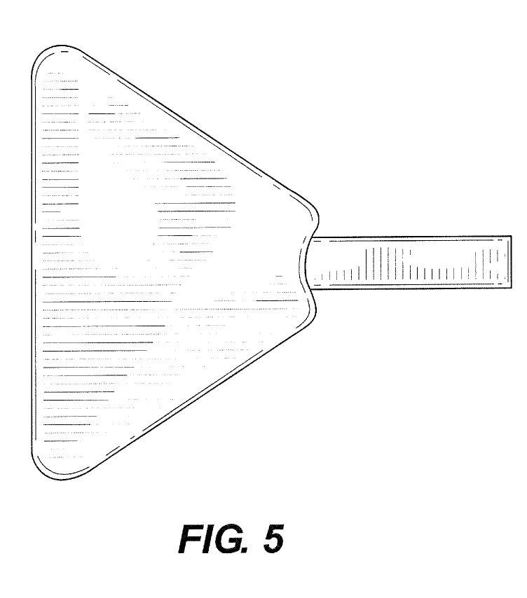

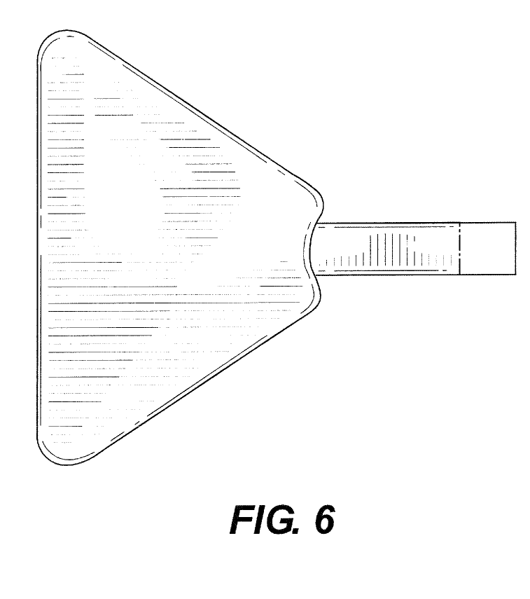

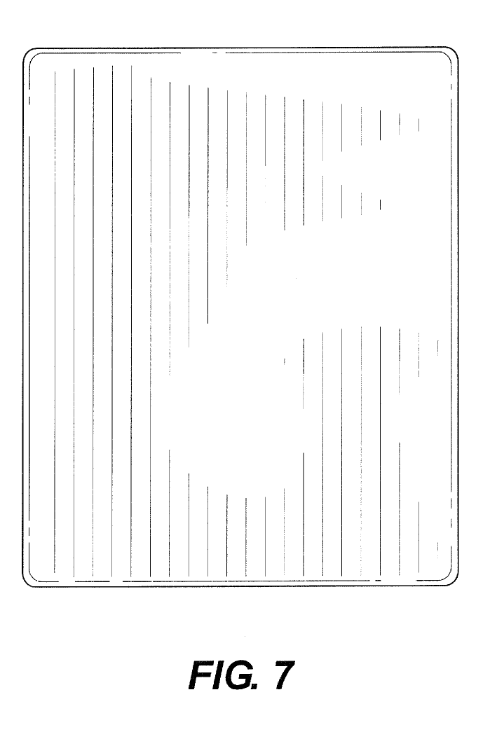

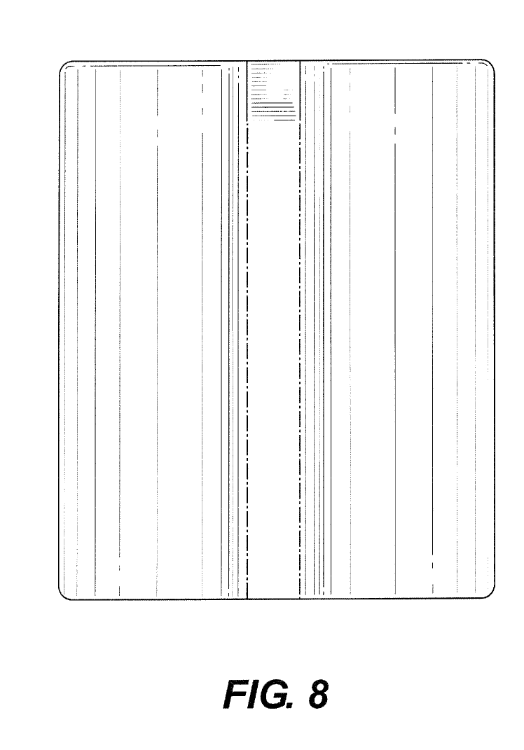

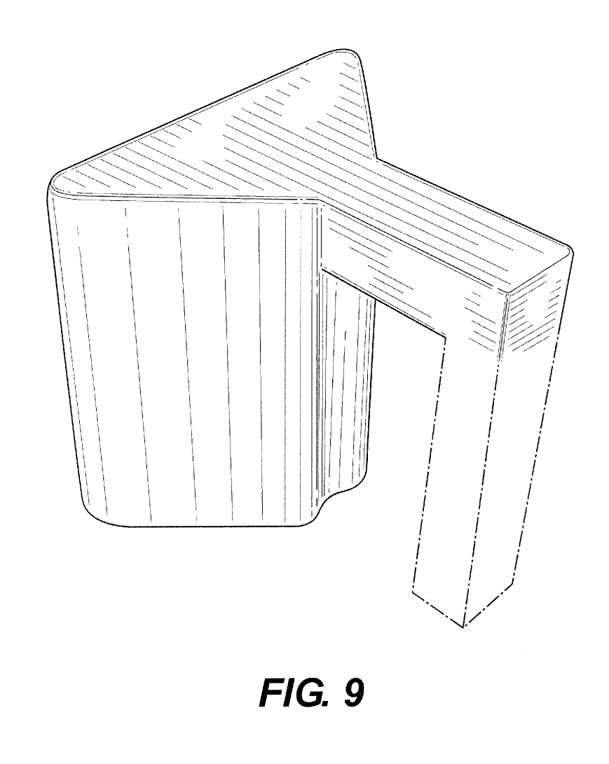

FIGS. 3-9 are perspective design drawings depicting the ornamental features of an exemplary embodiment of the present invention. As shown, the downward portion of the handle is illustrated with phantom lines.

While the invention has been described in connection with what is presently considered to be the preferred embodiment, it is to be understood that the invention is not to be limited to the disclosed embodiment, but on the contrary, is intended to cover various modifications and equivalent arrangements included within the spirit and scope of the appended claims.

What is claimed:

1. A door guard device comprising:
a handle attached to a wedge-portion, wherein the handle is constructed and adapted to be placed over a hinge attached to a door and door frame; and
the wedge-portion is constructed and adapted to fit between the edge of the door and the door frame, and is also constructed and adapted to ensure the door remains open at an angle with sufficient clearance to prevent a human finger from being injured in the cavity between the edge of the door and door frame.

2. The door guard device of claim 1, wherein the device is composed of silicone.

3. The door guard device of claim 1, wherein the device is composed of plastic.

4. The door guard device of claim 1, wherein the device is composed of a rubber material.

5. The door guard device of claim 1, wherein the device is composed of a wood material.

6. The door guard device of claim 1, wherein the device is composed of a metal material.

7. The door guard device of claim 1, wherein the wedge-portion has a concave inner area.

8. The door guard device of claim 1, wherein the wedge-portion is composed of a solid material.

9. The door guard device of claim 1, wherein the handle is constructed and adapted to first extend horizontally outward from the top of the wedge-portion at a distance such that the vertical portion of the handle fits securely over a hinge attached to a door and door frame.

10. The door guard device of claim 1, wherein the handle is constructed and adapted to first extend horizontally outward from the bottom of the wedge-portion at a distance such that the vertical portion of the handle fits securely under a hinge attached to a door and door frame, and can be further secured over the hinge.

11. A door guard device comprising:
a handle attached to a wedge-portion, wherein the handle is constructed and adapted to be placed over a hinge attached to a door; and
the wedge-portion is constructed and adapted to ensure the door remains open at an angle substantially corresponding to 90 degrees.

12. A door guard device comprising:
a handle attached to a wedge-portion, wherein the handle is constructed and adapted to be placed over a hinge attached to a door; and
the wedge-portion is constructed and adapted to ensure the door remains open at an angle substantially corresponding to 45 degrees.

13. A door guard device comprising:
a handle attached to a wedge-portion, wherein the handle is constructed and adapted to be placed over a hinge attached to a door and door frame; and
the wedge-portion is constructed and adapted to fit between the edge of the door and the door frame; wherein
the dimensions of the wedge-portion are adjustable by means of a device positioned between the angled sides of the wedge-portion; and
the wedge-portion adjusts about a hinge-device incorporated into the rear of the wedge-portion; and
the wedge-portion is also constructed and adapted to ensure the door remains open at an angle with sufficient clearance to prevent a human finger from being injured in the cavity between the edge of the door and door frame.

14. The door guard device of claim 13, wherein the device positioned between the angled sides of the wedge-portion is an adjustable pin, placed horizontally between the angled sides of the wedge-portion.

15. The door guard device of claim 13, wherein the device positioned between the angled sides of the wedge-portion is an adjustable spring, placed horizontally between the angled sides of the wedge-portion.
